(19) United States
(12) Patent Application Publication
(10) Pub. No.: US 2014/0269299 A1
(43) Pub. Date: Sep. 18, 2014

(54) NETWORK CONTROLLER NORMALIZATION OF NETWORK TRAFFIC

(71) Applicant: HEWLETT-PACKARD DEVELOPMENT COMPANY, L.P., Houston, TX (US)

(72) Inventor: Reinoud Jelmer Jeroen Koornstra, Sacramento, CA (US)

(73) Assignee: Hewlett-Packard Development Company, L.P., Houston, TX (US)

(21) Appl. No.: 13/803,060

(22) Filed: Mar. 14, 2013

(51) Int. Cl. H04L 12/24

(52) U.S. Cl. CPC H04L 41/28
USPC 370/235

(57) ABSTRACT

Methods, devices, and machine-readable and executable instructions are provided for normalizing network traffic using a network controller. An example method for normalizing network traffic using a network controller can include receiving network traffic, including a plurality of data units, at a network controller, and normalizing the network traffic based on a rule using the network controller.

### BACKGROUND

Entities can maintain networks with one or more connections to the Internet. Networks can include a plurality of resources connected by communication links, and can be used to connect people, provide services-both internally and externally via the Internet- and/or organize information, among other activities associated with an entity. Resources on the network can be susceptible to security attacks that originate either within the network or on the Internet. Security attacks can include an attempt to destroy, modify, disable, steal and/or gain unauthorized access to use of an asset (e.g., a resource, data, and information).

### BRIEF DESCRIPTION OF THE DRAWINGS

FIG. 1 is a diagram illustrating an example of a network according to the present disclosure.

FIG. 2 is a flow chart illustrating an example of a method for normalization of network traffic using a network controller according to the present disclosure.

FIG. 3 illustrates an example of a process of normalization of network traffic using a network controller according to the present disclosure.

FIG. 4 illustrates an example of a network controller according to the present disclosure.

### DETAILED DESCRIPTION

Currently, some entities may seek to avoid security attacks and/or identify a current security attack using a security prevention component (e.g., an intrusion detection system (IDS), an intrusion prevention system (IPS), and/or firewall, among other systems and/or processes). However, a fundamental problem of such components is the ability of security attackers to evade detection by exploiting ambiguities in network traffic (e.g., data and/or metadata associated with network traffic that can be interpreted multiple ways) as seen by the components. For instance, an IDS, IPS, and/or firewall may not have the ability to completely analyze information monitored (e.g., may not be able to reassemble Internet protocol (IP) fragments), may not have full knowledge of end device protocols (e.g., protocols of the machine that will receive the data units, such as how the machine will interpret overlapping IP fragments), and may not have full knowledge of network topology (e.g., resulting in poor analysis of time to life (TTL) field).

In some instances, an entity can attempt to resolve the evasion of detection by security prevention components by normalizing network traffic. Normalization of network traffic, as used herein, can include modification of a header field in a received data unit (e.g., frame, network packets, datagram) to resolve an ambiguity. For instance, a normalizer (e.g., an apparatus) can sit in the path of network traffic into a site and patch up the data stream (e.g., plurality of data units) to eliminate potential ambiguities before the network traffic is seen by the security prevention component. However, a normalizer may not have full knowledge of network topology and/or end device protocols (e.g., how an end device processes a data unit) of the network.

For instance, the normalizer is a static device that uses human intervention to implement changes to normalization procedures, such as updates to network topology. A security attacker can take advantage of the lack of knowledge to evade detection by the normalizer and/or a security prevention component. For example, during a period of time (e.g., a window of opportunity) that a normalizer does not know a correct network topology, a security attacker can evade the normalizer and/or cause the normalizer to make an incorrect decision.

In contrast, a number of examples of the present disclosure can utilize a network controller to monitor and dynamically normalize network traffic. The network controller can include a virtual and/or physical component that is designated and/or designed to exercise control over traffic in the network. The controller can maintain a set of network policies and network knowledge for routing and programming a flow table of network traffic. For instance, the network controller can be in communication with a plurality of network devices in the network, such as switches, routers, bridges and/or other hops in the network, to manage network traffic. The network controller can direct network traffic via a communication protocol with the plurality of network devices, and/or the network traffic can pass directly through the network controller. In either situation, the network controller may be aware of network topology of the network and/or any changes to the network topology.

When network traffic passes directly through the network controller, in accordance with examples of the present disclosure, the network controller can perform normalization on the network traffic. For instance, the network controller can modify any header field (e.g., a header field in an IP, transmission control protocol (TCP) and/or user datagram protocol (UDP) header) in a data unit (e.g., network packet, frame, and/or datagram). The ability to modify any field in a header (e.g., header field) from a data unit can cause the network traffic to appear as if each data unit is coming from the same device. This can make it challenging for a security attacker to learn the network topology of a network and/or to perform Network Address Translators (NAT)ted host counting (e.g., count the number of host devices behind a NAT box).

Furthermore, the network controller can modify normalization based on changes to network topology in real time and can respond to ambiguities without human intervention. Thereby, examples in accordance with the present disclosure can dynamically perform normalization of network traffic using a network controller without human intervention. Dynamically normalizing, as used herein, can include changing normalization processes in real time and/or without human intervention based on changes in the network.

As used herein, a data unit can include one or more headers and data to be transferred in a network. A header can include one or more header fields. Example data units can include a network packet, a frame, and a datagram, among other data units. Example headers can include an IP header, a TCP header, and a UDP header, among other headers.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

In addition, the proportion and the relative scale of the elements provided in the figures are intended to illustrate the examples of the present disclosure, and should not be taken in a limiting sense. As used herein, the designators “N” and “P” particularly with respect to reference numerals in the drawings, indicates that a number of the particular feature so designated can be included with a number of examples of the present disclosure. Also, as used herein, “a number of” an element and/or feature can refer to one or more of such elements and/or features.

FIG. 1 is a diagram illustrating an example of a network 100 according to the present disclosure. The network 100 can be a Layer 2 network and can include a network controller 102. The network controller 102 can include a software-defined networking (SDN) network controller. SDN is a form of network virtualization in which the control plane is separated from the data plane and implemented in a software application. Network administrators can therefore have programmable centralized control of network traffic without requiring physical access to the network's hardware devices. In some examples, the network controller 102 can be a discrete device, such as a server. In some examples, the network controller 102 can be a distributed network controller, for example, such as a cloud-provided functionality. One example of a protocol for SDN is OpenFlow, which is a communications protocol that gives access to the forwarding plane of a network switch over the network. Some examples of the present disclosure can operate according to an OpenFlow, or other SDN protocol, and/or a hybrid of an SDN protocol combined with “normal” (e.g., distributed control plane) networking.

The network controller 102 can be in communication with and/or have control over network devices 104-1, 104-2, 104-3, 104-4, 104-5, . . . , 104-N (herein referred to as “104”). For example, network devices 104 can be switches, routers, hubs, and/or bridges, among other devices and/or hops. Examples are not limited to the specific number of network devices 104 illustrated in the network 100.

The network controller 102 and the network devices 104 can be in communication using a communication protocol 103. For instance, the communication protocol 103 can include a communication link between the network controller 102 and the network devices 104 using a secure channel. The communication protocol 103, in various examples, can include an OpenFlow protocol. As an example, the network controller 102 can use the communication protocol 103 to manage the network devices 104.

According to some previous SDN approaches, the network controller (e.g., 102) can communicate with the network devices 104 to manage flow of network traffic without the network traffic passing through the network controller 102. The network controller 102 is aware of the network topology, points of interconnection, and end device protocols. Using this knowledge, the network controller 102 manages the control plane of the network 100 by running a function to construct data paths for traffic flow in the network 100. The result of the function can include a flow table that can be communicated to the network devices 104 via the communication protocol 103.

Controlling flow of network traffic can include managing the network devices 104, such as adding, updating, and/or deleting entries in a flow table located on each network device 104. A flow table can include, for instance, a set of flow entries, wherein each entry includes match fields, counters, and a set of instructions to apply to matching data units (e.g., network packet, a frame, and/or a datagram). As the network devices 104 receive data units, the network devices 104 can use the path table to determine if the data units match a flow existing in the table. If a data unit matches a flow in the flow table, the instructions associated with the specific flow entry is executed. A matching flow entry can, for instance, result in forwarding a data unit to a port (e.g., physical or virtual port). A flow can include, for instance, a set of data units (e.g., a sequence of data units) that share multiple end points (e.g., from a source to a destination). In some instances, a flow can be defined based on a time period (e.g., between multiple end points within a threshold period of time).

If a match is not found, a network device (e.g., 104) can forward the data unit to the network controller 102 to seek input. The network controller 102 can determine a data path for the data unit and send the decision to the network device (e.g., 104) via the network protocol 103. However, using such previous approaches, the network controller 102 may not monitor each data unit in the network traffic stream. That is, the network controller 102 may not analyze all header fields in a bit by bit analysis.

In contrast, in accordance with examples of the present disclosure, the network controller 102 can receive network traffic (e.g., data units pass directly through the network controller 102). The network controller 102 can perform (e.g., run) a function to construct a data path for traffic flows in the network 100. Data paths, as used herein, can include route paths (e.g., among network devices 104) of incoming data units to an end device (e.g., device that a data unit ends at and/or endpoint of a data path). In various examples, as illustrated by the example of FIG. 1, an end device can include a host device 106-1, 106-P (e.g., a desktop computer, a laptop computer, a tablet computer, and/or a mobile telephone). The data path (e.g., between network devices 104 and end devices) for traffic flows can be determined proactively (e.g., before the data units arrive at the network controller 102) and/or reactively (e.g., as the data unit and/or new data unit arrives at the network controller 102).

An example data path, as illustrated in the example of FIG. 1, can include a data unit sent from a first host device (e.g., 106-1). The first host device 106-1 can send the data unit to the network controller 102 via a communication link 108-1. The network controller 102 can determine a data path for the data unit (e.g., prior to receiving and/or after receiving the data unit) using a function. The data path can include a path among the plurality of network devices 104 to an end device. Of note, the network devices 104 are indicative of any number of network devices 104 there between depending on the size of the network 100. Although not specifically illustrated as such, an end device can alternatively be a server and/or a switch, rather than a host device (e.g., 106-1, 106-P).

For instance, the data path can be from the first host device (e.g., host device 106-1) to the network controller 102 to a first network device (e.g., network device 104-1) to a second network device (e.g., network device 104-2) to a third network device (e.g., network device 104-5) to a second host device (e.g., host device 106-P). A network device (e.g., particular network device 104-1) can communicate with other network devices (e.g., particular network device 104-2, 104-3, 104-4, 104-5, and 104-N) based on interconnections (e.g., communication links as illustrated by the lines connecting network devices 104 in FIG. 1) and/or with host devices 106-1, 106-P using communication links within the network (e.g., as illustrated by the arrows 105-1 and 105-P). The communication links (e.g., between network devices 104, host devices 106-1, 106-P, and/or the communication protocol 103) can include secure channels.

The network controller 102 can, for instance, be utilized to normalize the network traffic in the network 100. For instance, the network controller 102 can monitor network traffic (e.g., network traffic can pass through the network controller 102 as illustrated by the arrows 108-1, 108-P from the host devices 106-1, 106-P to the network controller 102), normalize received data units, and direct the flow of the normalized data units using the network devices 104. The network controller 102 can dynamically normalize the network traffic, in various examples (e.g., change normalization process in real time and/or without human intervention based on changes in the network 110).

The network controller 102 can include a processing resource in communication with a memory resource. The memory resource can include a set of instructions, executable by the processing resource to perform a number of functions described herein. For example, the network controller 102 can identify a network topology of a network 100. The identification can be based on communication with the network devices 104 using the communication protocol 103.

Network topology, as used herein, can include an arrangement of devices of a network. Such devices can include network devices 104 (e.g., switches, routers, hubs, and/or bridges), servers, end devices and/or host devices 106-1, 106-P, among other devices. Network topology can include physical topologies and/or logical topologies. Physical topology can refer to the placement of devices within a network 100 (e.g., network devices 104, servers, end devices, and/or host devices 106-1, 106-P). Logical topology can include data flows within a network, regardless of the network's physical design (e.g., a description of how data units pass through the network from one device to the next without regard to the physical interconnection of the devices).

For instance, the network controller 102 can identify a network topology of the network 100 by the network devices 104 forwarding link layer discovery protocol (LLDP) advertisements received on their links (e.g., from peer network devices, such as peer switches) to the network controller 102. The network controller 102 can parse the LLDP advertisements and use the information to identify the plurality of network devices 104 and their points of interconnection. Alternatively and/or in addition, the network topology can be input to the network controller 102 by a user (e.g., the information can be stored in a file and/or database) and the LLDP advertisements can be used to automatically update the network topology in response to changes.

The network controller 102 can monitor network traffic including a plurality of received data units (e.g., sent by the host devices 106-1, 106-P represented by the arrows 108-1, 108-P). The monitoring can include, for instance, reading and/or identifying header fields in each of the plurality of received data units. Thereby, network traffic can pass directly through the network controller 102.

Further, the network controller 102 can determine (e.g., identify) a rule for normalization and normalize the plurality of received data units based on the rule. In some instances, the rule can be based on the identified network topology. The rule can, for example, be a function (e.g., an algorithm) and/or a set of rules.

For instance, the function can be published to the network controller 102 using a communication link within the network 100. The network controller 102 can utilize the function to identify an ambiguity in a header field of a data unit and/or to normalize the header field. A set of rules, as used herein, can include a set of rules wherein each rule in the set is associated with one of a plurality of header fields. A header field can, for instance, include a header field of a received data unit.

Normalizing a data unit, as used herein, can include modifying a header field in the data unit using the network controller 102. Normalization can be based on an identified ambiguity in a header field, in some instances. As an example, a network controller 102 can modify a time to live (TTL) bit in a data unit to ensure that an end device receives and/or does not receive the data unit. The modification can be based on the identified network topology. For instance, the network controller 102 can identify that the TTL does not have sufficient hops to reach an end device and can modify the TTL based on the known network topology so that the data unit reaches the end device (e.g., host device 106-1, 106-P).

In some examples, one or more header fields of each of a plurality of received data units can be modified by the network controller 102. Such modification can be based on identified ambiguities in each of the plurality of data units and/or can be an automatic modification made to network traffic to make the network traffic appear as if the data units are coming from a single device. An automatic modification, in various examples, can include multiple modifications to a data unit (e.g., modifying several header fields and/or modifying several headers). Such a modification can make it more difficult for a security attacker to learn the network topology and/or to count NATted hosts within the network 100.

For instance, the network controller 102 can modify any header field in a data unit. Header fields can include IP, TCP and/or UDP header fields of a data unit. Example header fields can include version, header length, type of service (TOS)/different service (Diffserv)/explicit congestion notification (ECN), total length, IP identifier, must be zero, don't fragment flag (DF), more fragments flag (MF), fragment offset, TTL, protocol, and/or options, among other header fields.

In addition, using the network controller 102 to normalize network traffic can prevent and/or deter security attackers from fingerprinting the operating system (OS) of a host device (e.g., host devices 106-1, 106-P). A security attacker can fingerprint an OS of a host device (e.g., 106-1, 106-P) by putting an invalid value into a TOS field of an IP header of a data unit. The OS of the host device, in some instances, may respond to the data unit with the invalid TOS field and/or may modify the TOS field to a default value. Security attackers can predetermine how particular OSes and/or versions of OSes will respond to an invalid TOS field and can use this predetermination to fingerprint (e.g., determine) an OS of a host device (e.g., based on how the particular device returns the invalid TOS field).

Further, security attackers can determine an initial TTL value sent from a host device (e.g., 106-1, 106-P). Several OSes can use different initial TTL values. Combining knowledge of the initial TTL value with the return on the invalid TOS field, a security attacker may have sufficient information to determine and/or guess a particular OS of a host device (e.g., 106-1, 106-P). Additional fingerprinting test to determine an OS of a host device are known and/or can be used by security attackers. In contrast, normalizing network traffic using the network controller 102 can prevent fingerprinting by a security attacker as the network controller 102 may modify an ambiguity and/or automatically modify header fields. The modification of an ambiguity and/orautomatic modification can prevent a security attacker from learning knowledge of an OS of one or more host devices (e.g., 106-1, 106-P).

FIG. 2 is a flow chart illustrating an example of a method 210 for normalization of network traffic using a network controller according to the present disclosure. Normalization of network traffic using the method 210 can, for instance, include dynamic normalization of network traffic based on network knowledge (e.g., network topology, end device protocols, changes in network topology, identification of a security attack at a device).

At block 212, the method can include receiving network traffic, including a plurality of data units, at a network controller. Receiving network traffic, as used herein, can include passing network traffic through the network controller. Passing network traffic through the network controller can allow the network controller to monitor the network traffic and perform normalization on the network traffic, for instance.

Monitoring the network traffic can include identifying header fields in a received data unit. For instance, identifying header fields can include analyzing (e.g., reading) each header field. The identified header fields can be compared to a rule to determine if a potential ambiguity exits in the data unit (e.g., as discussed further herein).

At block 214, the method can include normalizing the network traffic based on a rule using the network controller. For instance, normalizing the network traffic can include modifying a header field in a received data unit. The normalization can, for instance, include normalizing the data unit as the data unit is received by the network controller (e.g., real time). As an example, using a determined rule associated with a TTL, the network controller can modify the TTL in a received data unit based on the rule (e.g., the rule instructs the network controller when and/or how to modify the TTL).

In various examples, the rule can be published to the network controller using a communication link within the network. The rule, as used herein, can include a conditional statement associated with normalization of network traffic. The rule can include a rule associated with an ambiguity in a data unit, a general rule, a function, and/or a set of rules.

A rule associated with an ambiguity in a data unit, as used herein, can include a conditional statement (e.g., if/then clause) associated with an ambiguity in a header field of a data unit. For instance, assume a data unit has been received by a network controller that contains a TTL that the network controller identifies will not reach the end device (e.g., the TTL does not contain enough hops to reach the end device). The network controller can determine a rule associated with the TTL ambiguity to determine an appropriate modification to make to the TTL header (e.g., as discussed further herein). For instance, the TTL rule can include modify the TTL bit to reach the end device based on the number of hops to the end device. The network controller can determine the number of hops to an end device based on knowledge of the network topology.

A general rule, as used herein, can include a statement to modify a header field in each of a plurality of received data units. For instance, the modification using a general rule can result in the data units appearing as if they are each sent from a single machine. The general rule can, in some examples, include modification to a plurality of header fields and/or a plurality of headers.

A function (e.g., a rule that includes a function), as used herein, can include a relation between inputs (e.g., header fields of a received data unit) and a set of permissible outputs (e.g., unambiguous header fields). The function can, for instance, be used to determine if the network controller will modify a header field and/or which header fields to modify. The function can be published to the network controller using a communication link within the network, for instance.

A set of rules, as used herein, can include a plurality of rules. Each rule in the set can, for instance, be associated with one of the header fields in a received data unit. Thereby, each rule can be associated with a potential ambiguity in a header field of received data units.

The network controller can dynamically normalize network traffic (e.g., received data units) without human intervention. Dynamically normalizing network traffic can, for instance, include adjustments to normalization without human intervention based on changing conditions in the network. Changing conditions can include, for instance, changes to network topology (e.g., additional network devices, network device malfunctions, etc.). For example, the network controller can identify a change in network topology and can dynamically adjust routing of data units based on the change in network topology. The dynamic adjustment, in various examples, can be communicated to network devices (e.g., switches, routers, hubs, and/or bridges) to modify the route a received data unit is on as the data unit is already being routed (e.g., may re-route network traffic).

Dynamically normalizing network traffic without human intervention can eliminate and/or avoid providing a security attacker with the opportunity to evade detection by the network controller. For instance, the network controller can monitor network traffic, including data units received, and can identify and/or learn of changes made to the network traffic. By monitoring the network traffic, the network controller can identify problems and/or current security attacks without human intervention. In some instances, it may be beneficial to react to security attacks as soon as possible. As an example, a worm (e.g., standalone malware machine program) may replicate itself in order to spread to network devices and consume significant bandwidth. The network controller can react to a worm by stopping a stream of network traffic without human intervention.

FIG. 3 illustrates an example of a process 320 of normalization of network traffic using a network controller according to the present disclosure.

At 322, incoming data units can be received by the network controller. The incoming data units, as used herein, can include network traffic associated with the network. At 324, the network controller can read (e.g., analyze) the header fields of the received data units. The reading of the header fields (e.g., header fields of a data unit), as used herein, can include identification of the fields and metadata associated with each field.

At 326, the network controller can identify a rule. Identifying a rule can include determining a rule, for instance. The rule can include a rule associated with an ambiguity, a general rule, a function, a set of rules, and/or a combination thereof.

At 328, a determination can be made as to whether the rule includes a general rule. A general rule, as used herein, can include an instruction to modify a header field in each received data unit (e.g., independent from identifying an ambiguity). In various examples, the rule can include a plurality of rules (e.g., a general rule and rules associated with an ambiguity and/or a function).

In response to determining the rule does not include a general rule, at 330, a determination can be made as to whether an ambiguity exists in the received data units (e.g., network traffic stream). An ambiguity can include metadata in a header field that can be interpreted by an end device and/or other network device in multiple ways. An ambiguity can be associated with a particular header field of a particular data unit, a particular header field of a plurality of data units, and/or a plurality of header fields of a plurality of data units. In some instance, an ambiguity can include a stream of data units (e.g., caused by a worm).

In response to determining that an ambiguity exists, at 332, network traffic can be normalized by the network controller using the identified rule. For instance, normalization can include modifying a header field in a data unit to resolve the ambiguity. The modification of the header field can be determined based on the rule (e.g., the rule can include a conditional statement that instructs the network controller to modify the header field in a particular way).

The network controller can determine if further ambiguities exist, at 330. For instance, in various examples, a plurality of ambiguities may exist. The determination can be after, before, and/or during normalization of an identified ambiguity (e.g., at 332).

In response to determining that no ambiguities exist and/or any existing ambiguities have been resolved (e.g., the network traffic has been normalized), the network controller can route the network traffic at 334. Routing the network traffic, as used herein, can include distributing received data units. For instance, distribution can include directing the received data units along a plurality of data paths. In some instances, the plurality of data paths can be determined by the network controller by applying a function.

In various examples, the identified rule (e.g., at 326) can include a general rule. In response to identifying that the rule includes a general rule (e.g. at 328), the received data units can be normalized, at 336. For instance, the normalization based on a general rule can include modifying a header field in each received data unit. The modification of each data unit can result in the network traffic appearing (e.g., to an outside user and/or a security attacker) as though each data unit is received from a single device. In some examples, the general rule can include a modification to several header fields in each data unit received.

In response to normalizing the data units based on the general rule, at 338, a determination can be made as to whether an ambiguity exists in the received data units (e.g., network traffic stream). For instance, an ambiguity may not be resolved by the normalization using the general rule. In some examples, the rule can include a general rule in addition to a rule associated with an ambiguity and/or a set of rules. The determination can be after, before, and/or during normalization using a general rule (e.g., at 336).

In response to identifying that an ambiguity exists, at 336, the network traffic can be normalized by the network controller using the identified rule. For instance, normalization can include modifying a header field in a data unit to resolve the ambiguity. Further, the network controller can determine if further ambiguities exist, at 338. The determination can be after, before, and/or during normalization of an identified ambiguity (e.g., at 336).

In response to identifying that no ambiguities exist and/or any existing ambiguities have been resolved (e.g., the network traffic has been normalized), the network controller can route the network traffic at 340.

FIG. 4 illustrates an example of a network controller 402 according to the present disclosure. The network controller 402 can be analogous to the network controller 102 illustrated in FIG. 1. The network controller 402 can utilize software, hardware, firmware, and/or logic to perform a number of functions.

The network controller 402 can be a combination of hardware and program instructions configured to perform a number of functions (e.g., operations and/or actions). The hardware, for example, can include a processing resource 452 and a memory resource 454, such as a machine-readable medium (MRM) or other memory resources. A processing resource 452, as used herein, can include any number of processers capable of executing instructions stored by a memory resource 454. The memory resource 454 can be internal and/or external to the network controller 402 (e.g., the network controller 402 can include internal memory resources and have access to external memory resources). The program instructions (e.g., machine-readable instructions (MRI)) can include instructions stored on the MRM to implement a particular function (e.g., identify a set of rules for normalization of network traffic). The set of MRI can be executable by the processing resource 452. The memory resource 454 can be coupled to the network controller 402 in a wired and/or wireless manner. For example, the memory resource 454 can be an internal memory, a portable memory, a portable disk, and/or a memory associated with another resource, e.g., enabling MRI to be transferred and/or executed across a network such as the Internet.

The memory resource 454 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resource 452 can be coupled to, the memory resource 454 via a communication path 453. The communication path 453 can be local or remote to the network controller 402. Examples of a local communication path 453 can include an electronic bus internal to a device, where the memory resource 454 is in communication with the processing resource 452 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 453 can be such that the memory resource 454 is remote from the processing resource 452, such as in a network connection between the memory resource 454 and the processing resource 452. That is, the communication path 453 can be a network connection. Examples of such a network connection can include local area network (LAN), wide area network (WAN), personal area network (PAN), and the Internet, among others.

As shown in FIG. 4, the MRI stored in the memory resource 454 can be segmented into a number of modules 456, 458, 460, 462, 464 that when executed by the processing resource 452 can perform a number of functions. As used herein a module includes a set of instructions included to perform a particular task or action. The number of modules 456, 458, 460, 462, 464 can be sub-modules of other modules. For example, the ambiguity module 460 can be a sub-module of the monitor module 458 and/or the ambiguity module 460 and the monitor module 458 can be contained within a single module. Furthermore, the number of modules 456, 458, 460, 462, 464 can comprise individual modules separate and distinct from one another. Examples are not limited to the specific modules 456, 458, 460, 462, 464 illustrated in FIG. 4.

The network controller 402 can include a rules module 456. The rules module 456 can include MRI that when executed by the processing resource 452 can identify a set of rules for normalization of network traffic. The identification can be based on, for instance, a set of rules published to the network controller 402.

The network controller 402 can include a monitor module 458. The monitor module 458 can include MRI that when executed by the processing resource 452 can monitor a plurality of received data units. That is, network traffic can pass directly through the network controller 402.

The network controller 402 can include an ambiguity module 460. The ambiguity module 460 can include MRI that when executed by the processing resource 452 can identify an ambiguity in a data unit among the plurality of received data units. The ambiguity can be associated with the data unit and/or a subset of the plurality of data units. Example ambiguities can include overlapping fragments with differing content and/or a TTL that will result in a data unit not reaching an intended end device, among other ambiguities.

The network controller 402 can include a normalizing module 462. The normalizing module 462 can include MRI that when executed by the processing resource 452 can modify a header field in the data unit based on the identified ambiguity and a rule among the set of rules to normalize the data unit. The normalization performed by the network controller 402 can include dynamic normalization, for instance.

For instance, assume the ambiguity is overlapping fragments with differing content. The network controller 402 can reassemble the incoming fragments and/or re-fragment the data unit for transmission if it is larger than maximum transmission unit (MTU). As a further example, assume the ambiguity is the TTL. The network controller 402 can modify the TTL bit to match other data units in the stream.

In some instances, a TTL can be modified by the network controller 402 to remedy a routing loop. A routing loop, as used herein, can include a continuous transfer of data (e.g., data unit) within a network. The data in the routing loop may not reach an end device (e.g., a particular destination). The network controller 402 can have knowledge of the existence of a routing loop (e.g., due to management and/or communication with the network devices) and adjust the TTL to prevent the data from looping. The network controller 102 can communicate with network devices (e.g., switches and/or routers) to prevent the possibility of a loop in the first place and/or to correct an existing loop.

In some instances, a software application, such as a multicast application, can use expanding ring searches. The network controller 402 can identify and/or have knowledge of such a software application and/or data units used for this and may not adjust the TTL for such data units.

Further, the network controller 402 can include a distribute module 464. The distribute module 464 can include MRI executable by the processing resource 452 to distribute the plurality of received data units, including the normalized data unit, along a plurality of data paths.

For instance, the network controller 402 can instruct the network devices (e.g., a plurality of switches and/or routers) to distribute the plurality of data units along the plurality of data paths (e.g., data path for traffic flows). The instruction can, for instance, be based on a communication protocol between the network controller 402 and the network devices. The network traffic can be forwarded by the network devices as directed by the network controller 402. For example, the network controller 402 can determine the data paths of the plurality of data units, wherein each data path can include a path among the plurality of network devices to an end device. The determination can be based on a function and the network controller 402 can instruct the network devices based on the determination.

In some examples, the network controller 402 can instruct network devices and/or can direct the plurality of received data units to a security prevention component of the network. A security prevention component can include, for instance, an IDS, an IPS, and/or a firewall. The security prevention component can be used to detect and/or prevent potential security attacks and/or identify security threats in the network.

Alternatively and/or in addition, the network controller 402 can detect eluding and evasion security attacks based on the monitoring of the plurality of received data units. For instance, the monitoring can include a bit by bit analysis of header fields. The bit by bit analysis by the network controller 402 can result in better identification of data units intended to evade and elude (e.g., security attacks) than a security prevention component can do.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A method for normalization of network traffic using a network controller, the method comprising:
receiving network traffic, including a plurality of data units, at the network controller; and
normalizing the network traffic based on a rule using the network controller.

2. The method of claim 1, wherein the method includes publishing the rule to the network controller using a communication link within the network, wherein the rule includes a function.

3. The method of claim 1, wherein the method includes publishing the rule to the network controller using a communication link within the network, wherein the rule includes a set of rules and wherein each rule in the set is associated with one of a plurality of header fields in the plurality of data units.

4. The method of claim 1, wherein normalizing the network traffic includes normalizing one of the plurality of data units as the data unit is received by the network controller.

5. The method of claim 1, wherein the method includes:
identifying a change in network topology using the network controller; and
dynamically adjusting routing of one of the plurality of data units based on the change in network topology.

6. The method of claim 1, wherein normalizing the network traffic includes modifying metadata in a header field of one of the plurality of data units.

7. The method of claim 1, wherein normalizing the network traffic includes dynamically normalizing the network traffic without human intervention.

8. A non-transitory machine-readable medium storing instructions executable by a network controller to cause the network controller to:
identify a network topology of a network;
monitor network traffic, including a plurality of received data units;
determine a rule for normalization based on the identified network topology; and
normalize the network traffic based on the rule.

9. The medium of claim 8, wherein the instructions executable to monitor network traffic include instructions to monitor the plurality of received data units passing through the network controller.

10. The medium of claim 8, wherein the instructions to normalize the network traffic include instructions to modify a header field of one of the plurality of received data units based on an identified ambiguity.

11. The medium of claim 8, wherein the instructions to normalize the network traffic include instructions to modify a header field of each of the plurality of received data units.

12. A network controller, comprising:
a processing resource in communication with a memory resource, wherein the memory resource includes a set of instruction executable by the processing resource to:
identify a set of rules for normalization of network traffic;
monitor a plurality of received data units;
identify an ambiguity in a data unit among the plurality of received data units;
modify a header field in the data unit based on the identified ambiguity and a rule among the set of rules to normalize the data unit; and
distribute the plurality of received data units, including the normalized data unit, along a plurality of data paths.

13. The network controller of claim 12, wherein the set of instruction executable by the processing resource to distribute the plurality of received data units includes instructions to direct the plurality of received data units to a security attack prevention component of the network.

14. The network controller of claim 12, wherein the set of instruction is executable by the processing resource to determine how to distribute the data units among a plurality of network devices.

15. The network controller of claim 12, wherein the set of instruction is executable by the processing resource to detect eluding and evasion security attacks based on the monitor of the plurality of received data units.
